(19) United States
(12) Patent Application Publication
(10) Pub. No.: US 2018/0253952 A1
(43) Pub. Date: Sep. 6, 2018

(54) SMART WALL-MOUNTED SOCKET

(71) Applicant: SOLYTECH ENTERPRISE CORPORATION, NEW TAIPEI CITY (TW)

(72) Inventor: BING-ZHOU HUANG, NEW TAIPEI CITY (TW)

(21) Appl. No.: 15/448,596

(22) Filed: Mar. 3, 2017

(51) Int. Cl. G08B 15/00; H04L 12/28; G08B 13/22; G08B 17/06; G08B 21/18

(52) U.S. Cl. CPC G08B 15/001; H04L 12/2825; G08B 13/22; H04L 2012/2841; G08B 21/182; H04L 2012/2843; G08B 17/06

(57) ABSTRACT

A smart wall-mounted socket includes a substantially square housing and a panel. The panel has a plurality of alternating current jacks and is connected to one side of the housing. The housing includes a power control module and a wireless network module having an antenna therein. The antenna is disposed in a wall of the housing abutting against the panel, or the antenna extends slightly out of the housing and abuts against the panel. The smart wall-mounted socket is directly embedded in a socket trough of a wall of a building and electrically connected with positive and negative wires of a mains electricity supply. The antenna transmits the power detection signal to the terminal controller without being interfered. Under the premise of low construction cost, the smart wall-mounted socket can achieve all aspects of home security monitoring network and high industrial economic benefits.

### FIELD OF THE INVENTION

The present invention relates to an electrical socket, and more particularly to a smart wall-mounted socket for directly replacing an existing wall-mounted socket to achieve a smart home with ease.

### BACKGROUND OF THE INVENTION

With the development of wireless network and cloud technology, the concept of “smart home” has become an emerging fashion trend. More and more appliances on the markets not only have self-monitoring functions but also have remote manipulation functions, allowing users to directly use a mobile APP (mobile application) to operate the household appliances wirelessly. The so-called smart home, namely, intelligent digital home, is to ensure that digital lifestyle will not affect the user's personal preferences, lifestyle and habits, and enhances the safety of buildings, health, energy saving, convenience and comfort. It includes home security monitoring, temperature and humidity, light, and air quality, gas and fire warnings, power saving settings, and so on.

It is well known to those skilled in the art that the term “digital” is derived from the application of telecommunication. A conventional smart socket system 1, as shown in FIG. 1, tends to modify the power socket, with low-cost components to enhance the home quality. The smart socket system 1 is provided with a plurality of plugs 10 having an NFC chip and a socket 11 having a power state notification module. The socket 11 is wirelessly connected with a power monitoring device 13 and provided with a plurality of socket modules 110 having sensing units. Each of the plugs 10 is electrically connected to an electrical appliance 12. When the plug 10 is plugged into the socket module 110, the sensing unit may wirelessly sense the identity information of the NFC chip, and the power state notification module may measure the output power of each of the socket modules 110 to output power consumption data to the power monitoring device 13, so that the user can remotely monitor the power consumption state of the electric appliances 12. The above smart sockets have been used on the market. However, no matter what kind of smart socket, it is an independent power extension module. That is, it has to be plugged into the existing wall-mounted socket for transmitting power, rather than being directly embedded in the wall of the building when the power wiring is arranged. Thus, how to improve the wall-mounted socket in consideration of the wireless network transmission function without being influenced by the wall and electromagnetic interference, and makes it possible to realize the smart digital home through the wall-mounted socket having the multi-detection function and the wireless transmission function directly.

Accordingly, the inventor of the present invention has devoted himself based on his many years of practical experiences to solve these problems.

### SUMMARY OF THE INVENTION

In view of the problems of the prior art, the primary object of the present invention is to provide a smart wall-mounted socket conforming to the specification of the existing socket trough of the wall, allowing users to replace the existing wall-mounted socket at will to monitor the power while achieving a tidy home environment.

In order to achieve the aforesaid object, the smart wall-mounted socket comprises a power control module and a wireless network module having an antenna for electrical connection of at least one electrical apparatus. The power control module is used to detect a power consumption state of the electrical apparatus and then transmit a power detection signal to a terminal controller through the wireless network module. The smart wall-mounted socket includes a substantially square housing and a panel. The panel has a plurality of alternating current jacks and is connected to one side of the housing. The wireless network module is disposed in the housing. The antenna is disposed in a wall of the housing abutting against the panel or the antenna extends slightly out of the housing and abuts against the panel. The smart wall-mounted socket is directly embedded in a socket trough of a wall of a building and electrically connected with positive and negative wires of a mains electricity supply. The antenna transmits the power detection signal to the terminal controller without being interfered.

Wherein, the socket trough of the wall is adapted to accommodate a 86 type, 118 type, 146 type, or 120 type socket. The power control module is disposed in the housing far away from the panel. The wireless network module is disposed in the housing near the panel. The housing is integrally formed. When a front side of the housing is connected to the panel, the housing is a closed square housing. The power control module has a positive power line and a negative power line inserted through a rear side of the housing to be respectively connected with the positive and negative wires of the mains electricity supply. The wireless network module transmits the power detection signal to the terminal controller through at least one of WiFi, ZigBee and Bluetooth. The power control module is electrically connected with the mains electricity supply and transforms an alternating current voltage of the mains electricity supply into a direct current voltage. The panel has at least one USB port or at least one Type C jack for electrical connection of the electrical apparatus so as to get the direct current voltage directly.

Furthermore, the housing includes at least one of a temperature sensing module, a humidity sensing module, a light sensing module, an infrared distance sensing module, an image detection module, a smoke sensing module, and an air quality detection module therein for respectively sensing room temperature, humidity, human activity, indoor conditions in the building to form at least one of a temperature signal, a humidity signal, an access control signal, a burglar signal, a fire alarm signal, and an air signal to be transmitted to the terminal controller through the wireless network module to achieve burglarproof and disaster prevention functions and to enhance the indoor comfort. The terminal controller is provided with an application program for at least one user to directly control the operation of the power control module through the application program. The wireless network module transmits at least one of the power detection signal, the temperature signal, the humidity signal, the access control signal, the burglar signal, the fire alarm signal, and the air signal to a cloud server for the user to check or analyze. When there is an abnormality, the application program alerts the user by mans of text, voice, or video.

In view of the above, the smart wall-mounted socket of the present invention has a plurality of detection functions and wireless transmission functions, so that the user can directly install it in the building or replace the existing wall-mounted socket for detecting the static environment and the dynamic environment by means of a network, allowing the user to remotely monitor the indoor conditions at any time to achieve environmental quality maintenance, access control security, disaster prevention, and so on for a smart home. Thus, unlike the commercially available smart sockets, the smart wall-mounted socket of the present invention breaks through the difficulty of the antenna being limited by the wall of the building and by electromagnetic interference and overcome the problem that it is difficult to be mounted in a housing. Without spending a lot of money and labors to reconstruct or decorate the building, the present invention can low construction costs to complete all aspects of home security monitoring system and to achieve high industrial economic benefits.

### BRIEF DESCRIPTION OF THE DRAWINGS

FIG. 1 is a schematic view of a conventional smart socket system when in use;

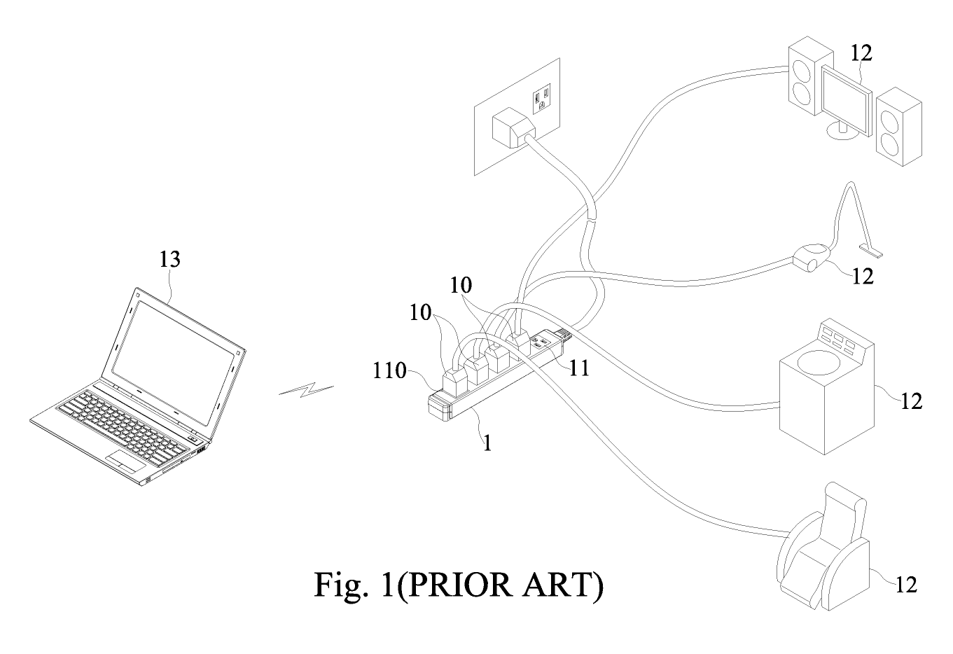

FIG. 2 is a block diagram of a preferred embodiment of the present invention;

FIG. 3 is a schematic view of a socket according to the preferred embodiment of the present invention;

FIG. 4 is a schematic view of an application according to the preferred embodiment of the present invention;

FIG. 5 is a schematic view of an application grogram according to the preferred embodiment of the present invention; and

FIG. 6 is another block diagram of a preferred embodiment of the present invention.

### DETAILED DESCRIPTION OF THE PREFERRED EMBODIMENTS

Embodiments of the present invention will now be described, by way of example only, with reference to the accompanying drawings.

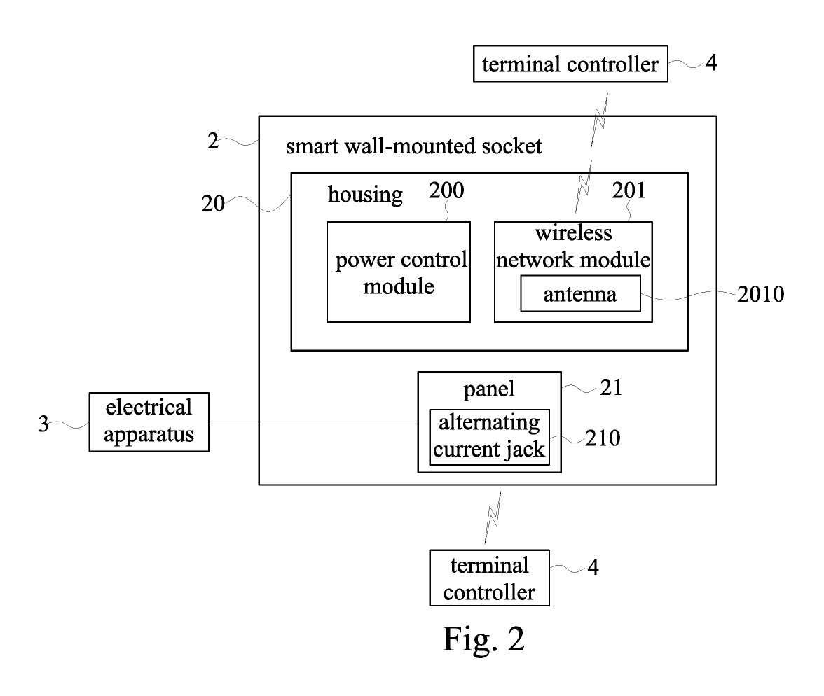

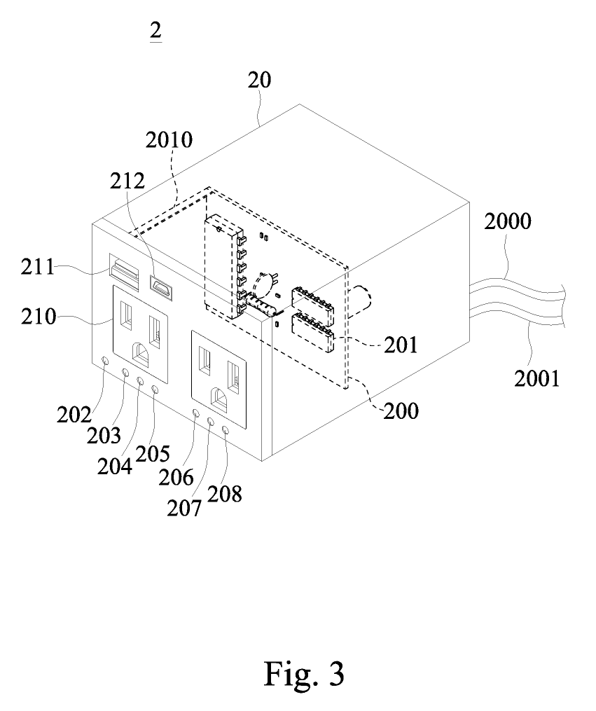

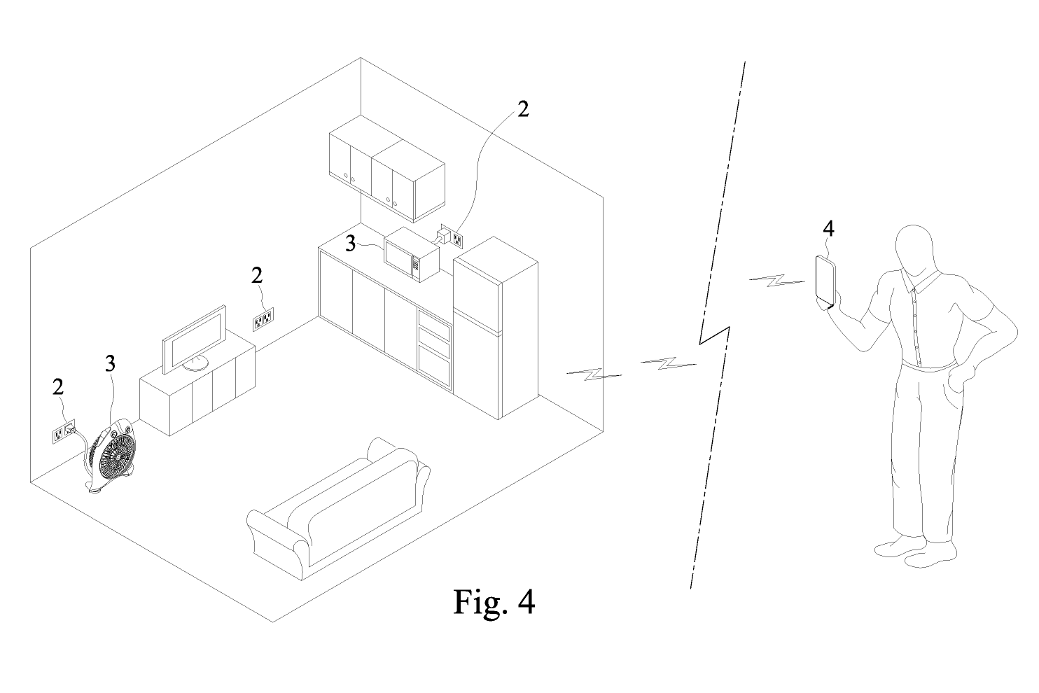

As FIG. 2 is a block diagram of a preferred embodiment of the present invention. FIG. 3 is a schematic view of a socket according to the preferred embodiment of the present invention. FIG. 4 is a schematic view of an application according to the preferred embodiment of the present invention. The present invention discloses a smart wall-mounted socket 2 which may be 86 type, 118 type, 146 type, or 120 type socket to be directly embedded in a socket trough (not shown) of the wall of a building for electrical connection of at least one electrical apparatus 3. The smart wall-mounted socket 2 includes a substantially square housing 20 and a panel 21. The panel 21 has a plurality of alternating current jacks 210 and is connected to one side of the housing 20. The number of the alternating current jacks 210 may be two or three, but not limited to any type. The housing 20 is integrally formed. When a front side of the housing 20 is connected to the panel 21, the housing 20 is a closed square housing. The housing 20 may include a power control module 200 and a wireless network module 201 therein. The power control module 200 is disposed in the housing 20 far away from the panel 21, and has a positive power line 2000 and a negative power line 2001. The positive power line 2000 and the negative power line 2001 are inserted through a rear side of the housing 20 to be respectively connected with positive and negative wires (not shown) of a mains electricity supply. The power control module 200 is electrically connected with the alternating current jacks 210 through a plurality of relays (not shown), respectively. The wireless network module 201 is disposed in the housing 20 near the panel 21, and is electrically connected with the power control module 200. The wireless network module 201 has an antenna 2010. The antenna 2010 is disposed in the wall of the housing 20 abutting against the panel 21, or the antenna 2010 extends slightly out of the housing 20 and abuts against the panel 21, so that the antenna 2010 can transmit signals without being obstructed by the wall of the building or by electromagnetic interference.

The wireless network module 201 may be connected with a terminal controller 4 and a cloud server (not shown) by electrical communication. When the power control module 200 detects the magnitude of the output current of each of the alternating current jacks 210 and the current output time to form a power detection signal, the wireless network module 201 transmits the power detection signal to at least one of the terminal controller 4 and the cloud server through a wireless transmission means, such as wireless mobile signal, WiFi, ZigBee or Bluetooth, for informing the user that the relay of each alternating current jack 210 is actuated by the terminal controller 4 to cut off the power supply to the corresponding electrical apparatus or to adjust the magnitude of the output current from each of the alternating current jacks to affect the actuation state of the corresponding electrical apparatus.

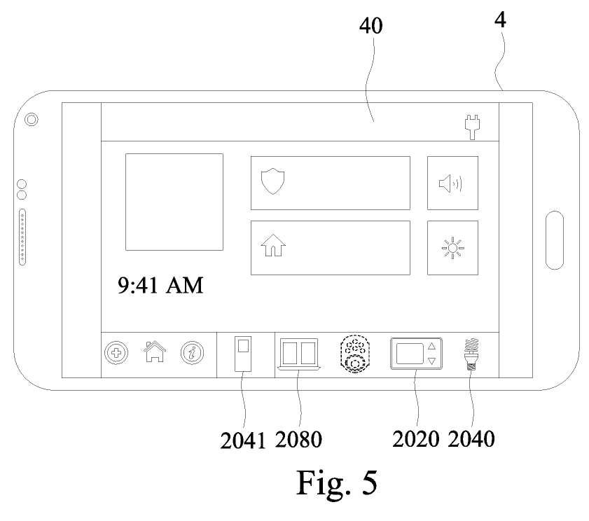

In an embodiment, the panel 21 may further have at least one USB port 211 and at least one Type C jack 212. The power control module 200 may directly distribute the mains electricity supply through the alternating current jacks 210, or an alternating current voltage of the mains electricity supply is transformed into a direct current voltage and then the direct current voltage is supplied to the electrical apparatus 3 through the USB port 211 or the type C jack 212 to facilitate the direct application of 3C products. The housing 20 may further include at least one of a temperature sensing module 202, a humidity sensing module 203, a light sensing module 204, an infrared distance sensing module 205, an image detection module 206, a smoke sensing module 207, an air quality detection module 208, a wireless reed switch 209, an LED lamp 22, and a magnetic amplifier 23 therein. The temperature sensing module 202, the humidity sensing module 203, the light sensing module 204, the infrared distance sensing module 205, the image detection module 206, the smoke sensing module 207, the air quality detection module 208, the wireless reed switch 209, and the LED lamp 22, and the magnetic amplifier 23 are electrically connected with the power control module 200 and the wireless network module 201, respectively. The terminal controller 4, such as a mobile phone, a tablet computer, a computer or the like, may be provided with an application program 40, as shown in FIG. 5. The application program 40 displays the images of the room temperature, brightness, air quality, environmental safety, building access control, and security system lock. The images may be displayed after the application program 40 successfully matches all of the smart wall-mounted sockets 2 in the building for the user to be aware of the functions controlled by the smart digital home through the smart wall-mounted sockets 2. Alternatively, the application program 40 displays all of the functions those the smart wall-mounted socket 2 may have and displays only the functions those the smart digital home can control, in a different manner of light and shade images, after successful match.

The aforesaid various sensing or detection modules may be used alone or in combination in a single smart wall-mounted socket 2. The commercialized smart wall-mounted sockets 2 may have different combinations of sensing or detection modules. For example, the temperature sensing module 202, the humidity sensing module 203, and the smoke sensing module 207 may be used independently to sense the temperature, humidity, and smoke level in the building to form a temperature signal 2020, a humidity signal and a smoke signal to the power control module 200, and the signals are transmitted to the terminal controller 4 through the wireless network module 201 for the user to use the application program 40 to control the relay of each alternating current jack 210 to adjust the operation of air conditioners, dehumidifiers, water oxygen machines, exhaust fans or air filters so as to adjust the overall room temperature and humidity to enhance the indoor comfort. Alternatively, when the humidity sensing module 203 detects a decrease in humidity and the temperature sensing module 202 detects an increase in temperature, the power control module 200 transmits a fire alarm signal to the terminal controller 4 through the wireless network module 201 to alert the user of the attention and view. Further, when the humidity sensing module 203 detects a decrease in humidity and the temperature sensing module 202 detects an increase in temperature and the smoke sensing module 207 detects smoke, the power control module 200 transmits a fire alarm signal to the terminal controller 4 through the wireless network module 201.

The light sensing module 204 may be a brightness sensing device and may be used alone or in cooperation with the infrared distance sensing module 205 to detect the room brightness to form a brightness signal 2040 or to sense a human body or an object crossing a door or a window to form an access control signal 2041. The access control signal 2041 is transmitted through the wireless network module 201 to the terminal controller 4 for burglarproof use. Further, a plurality of smart wall-mounted sockets 2 are mounted at different heights, which can be used to distinguish whether the sensing result is a human or an animal, that is, when both infrared distance sensing modules 205 of different heights generate sensing signals at the same time, the sensing result is a human, such that the power control module 200 generates a burglar signal for the application program 40 to inform the user of close attention to the human activity and indoor conditions. On the other hand, if only the infrared distance sensing module 205 of the low installation position generates a sensing signal, it is an animal.

Moreover, the image detection module 206 may be further provided to further analyze whether the sensing result is a family member, a burglar, a cat or dog, or an insect to form the burglar signal accordingly. Of course, the application program 40 may transmit a message or instantaneous detection data to the user by text, voice or video, etc., to alert the user, while allowing the user to view the indoor real image captured by the image detection module 206 at any time.

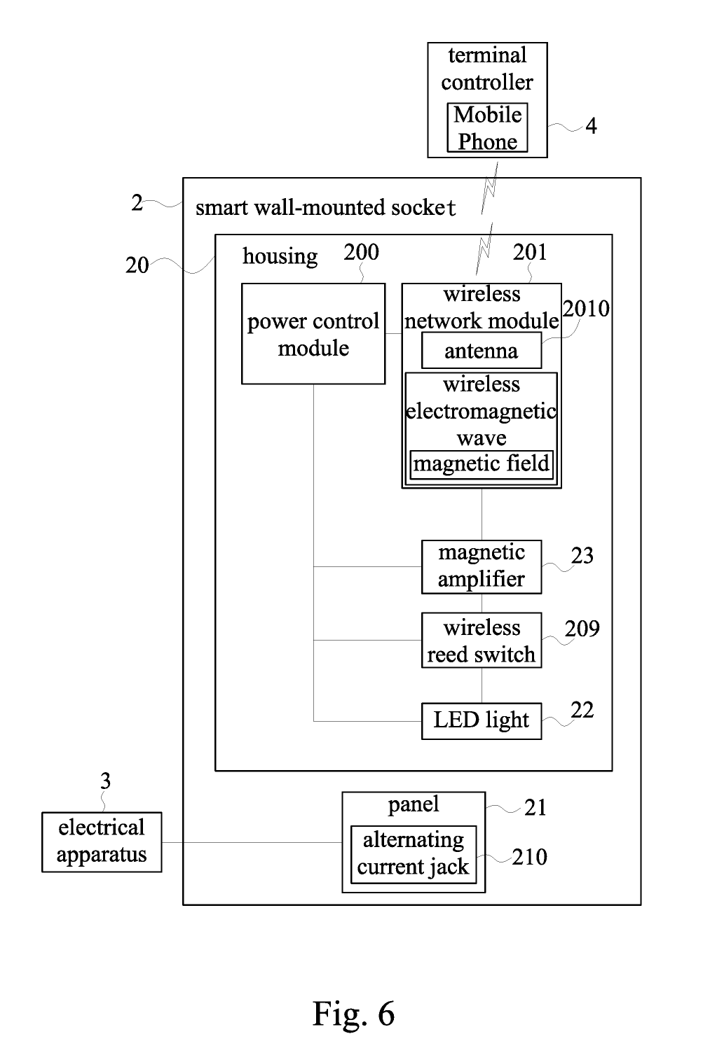

Please refer to FIG. 6, when a burglar signal is formed, the user can send signal to the wireless network module 201 remotely via terminal controller 4 to activate the wireless reed switch 209 and to turn on the LED lamp 22. The wireless reed switch 209 can be switched between a conducting state or an open circuit state via the change magnetic field. Therefore, signal can be sent remotely to the wireless network module 201 of the smart wall-mounted socket 2 by communicating with the terminal controller 4. In other words, the present invention uses the magnetic field of the electromagnetic wave of wireless communication signal to trigger the wireless reed switch 209 and actuate the LED lamp 22; and the LED lamp 22 can instantly emit light having brightness of 100 to 360 lumens to blind the burglar temporary so as to make time for the users to contact law enforcement personnel. In some embodiment, the magnetic amplifier 23 can be provided between the wireless network module 201 and the wireless reed switch 209 to boost the magnitude of the magnetic field of the wireless communication signal when necessary. An example of which can be the terminal controller 4 emits electromagnetic wave and causes the magnetic sensing element at the front section of the wireless reed switch 209 to sense the magnetic field of the electromagnetic wave, so as to open the power gate of the wireless reed switch 209 and allow the power control module 200 to provide sufficient power to an electromagnet of the wireless reed switch 209, and thereby to increase the magnitude of the magnetic field.

It is worth mentioning that the wireless network module 201 may synchronously transmit at least one of the power detection signal, the temperature signal 2020, the humidity signal, the brightness signal 2040, the access control signal 2041, the burglar signal, the fire alarm signal, and an air signal 2080 to the cloud server for the user to check or analyze the sensing data anytime anywhere. When receiving the access control signal 2041 or the burglar signal, the application program 40 can automatically synchronously make a phone call to the security unit to request for help, or when receiving the fire alarm signal or the air signal 20810, the application program 40 can synchronously make a phone call to the fire department.

In addition, the smoke sensing module 207 and the air quality detecting module 208 may be used alone or used together to sense the indoor air quality and smoke level to form an air signal 2080 when the indoor air quality is poor. The application program 40 alerts the user or drives the power control module 200 to turn on the relay of the alternating current jack 210 corresponding to the exhaust fan or the air filter to automatically operate the exhaust fan or the air filter. When the humidity sensing module 203 detects a decrease in humidity, or the humidity sensing module 203 detects a decrease in humidity and the air quality detection module 208 detects an abnormality in room air quality ratio, for example carbon dioxide and combustible gas content is too high or there is a lot of smoke, the power control module 200 determines that a gas leak or a fire may occur and transmits the fire alarm signal to the terminal controller 4 through the wireless network module 201 to warn the user of the fire alarm. The small wall-mounted socket 2 automatically switches off the relay of the corresponding alternating current jack 210, thereby realizing a disaster prevention function.

Although particular embodiments of the present invention have been described in detail for purposes of illustration, various modifications and enhancements may be made without departing from the spirit and scope of the present invention. Accordingly, the present invention is not to be limited except as by the appended claims.

1. A smart wall-mounted socket, comprising a power control module and a wireless network module having an antenna for electrical connection of at least one electrical apparatus, the power control module being used to detect a power consumption state of the electrical apparatus and transmit a power detection signal to a terminal controller through the wireless network module, characterized by:
the smart wall-mounted socket including a substantially square housing and a panel, the panel having a plurality of alternating current jacks and being connected to one side of the housing, the wireless network module being disposed in the housing, the antenna being disposed in a wall of the housing abutting against the panel or the antenna extending slightly out of the housing and abutting against the panel, the smart wall-mounted socket being directly embedded in a socket trough of a wall of a building and electrically connected with positive and negative wires of a mains electricity supply, the antenna transmitting the power detection signal to a terminal controller without being interfered,
wherein the smart wall-mounted socket comprises a light sensing module and an infrared distance sensing module for sensing a human body or an object to form an access control signal, the access control signal is transmitted through the wireless network module to the terminal controller,
wherein a plurality of smart wall-mounted sockets can be mounted at different heights to determine whether a human or an animal is present, when the infrared distance sensing modules of the plurality of smart wall-mounted sockets of different heights generate sensing signals at a same time, a sensing result of a presence of a human is determined, the power control module generates a burglar signal,
wherein each of the plurality of smart wall-mounted sockets comprises a lamp which can emit light having brightness of 100 to 360 lumens.

2. The smart wall-mounted socket as claimed in claim 1, wherein the socket trough of the wall is adapted to accommodate a 86 type, 118 type, 146 type, or 120 type socket.

3. The smart wall-mounted socket as claimed in claim 2, wherein the power control module is disposed in the housing far away from the panel, and the wireless network module is disposed in the housing near the panel.

4. The smart wall-mounted socket as claimed in claim 3, wherein the housing is integrally formed, when a front side of the housing is connected to the panel, the housing is a closed square housing, the power control module has a positive power line and a negative power line inserted through a rear side of the housing to be respectively connected with the positive and negative wires of the mains electricity supply.

5. The smart wall-mounted socket as claimed in claim 4, wherein the wireless network module transmits the power detection signal to the terminal controller through at least one of wireless mobile signal, WiFi, ZigBee and Bluetooth.

6. The smart wall-mounted socket as claimed in claim 5, wherein the power control module is electrically connected with the mains electricity supply and transforms an alternating current voltage of the mains electricity supply into a direct current voltage, the panel has at least one USB port or at least one Type C jack for electrical connection of the electrical apparatus so as to get the direct current voltage directly.

7. The smart wall-mounted socket as claimed in claim 6, wherein the housing further includes at least one of a temperature sensing module, a humidity sensing module, an image detection module, a smoke sensing module, an air quality detection module, and a wireless reed switch therein for respectively sensing room temperature, humidity, human activity, indoor conditions in the building to form at least one of a temperature signal, a humidity signal, an access control signal, a burglar signal, a fire alarm signal, an air signal, and a warning signal to be transmitted to the terminal controller through the wireless network module.

8. The smart wall-mounted socket as claimed in claim 7, wherein the terminal controller is provided with an application program for at least one user to directly control operation of the power control module through the application program.

9. The smart wall-mounted socket as claimed in claim 8, wherein the wireless network module transmits at least one of the power detection signal, the temperature signal, the humidity signal, the access control signal, the burglar signal, the fire alarm signal, and the air signal to a cloud server for the user to check or analyze, when there is an abnormality, the application program alerts the user by means of text, voice, or video.

10. The smart wall-mounted socket as claimed in claim 1, further comprising a wireless reed switch and a LED lamp, wherein the wireless reed switch is switched by a magnetic field of a wireless electromagnetic wave emitted by the terminal controller to turn on the LED lamp and to blind an intruder temporarily.
